(19) United States
(12) Patent Application Publication
(10) Pub. No.: US 2002/0172042 A1
(43) Pub. Date: Nov. 21, 2002

(54) Lighting fixture

(76) Inventor: Frank Tsao Wen-Chung, Sangchung City (TW)

Correspondence Address: JOSEPH E. MUETH LAW CORPORATION, 8TH FLOOR, 225 SOUTH LAKE AVENUE, PASADENA, CA, 91101, US

(21) Appl. No.: 09/922,903

(22) Filed: Aug. 6, 2001

Related U.S. Application Data
(60) Provisional application No. 60/291,750, filed on May 16, 2001.

(51) Int. Cl. F21S 8/02

(52) U.S. Cl. 362/276; 362/364; 362/147

(57) ABSTRACT

A night lighting fixture comprising a junction box including at least one front plate, within said junction box an electrical light source and light reflector, said fixture including a visible light detecting photocell, a first opening in said front plate for allowing external ambient light to reach said photocell, said photocell and light source being in electrical communication whereby said photocell is adapted to turn said light source off when the photocell detects ambient light and on when the photocell does not detect ambient light and another opening in said front plate to allow for the passage of light from said electrical light source to provide illumination in the external space.

A structural wall having a night lighting fixture comprising a junction box recessed within said wall, at least one front plate which is exposed on the surface of said wall, within said junction box an electrical light source and light reflector, said fixture including a visible light detecting photocell, a first opening in a front surface for allowing external ambient light to reach said photocell, said photocell and light source being in electrical communication whereby said photocell is adapted to turn said light source off when the photocell detects ambient light and on when the photocell does not detect ambient light and another opening in a said front surface to allow for the passage of light from said electrical light source to provide illumination in the external space.

This patent application claims the benefit of Provisional Application Serial No. 60/291,750, filed May 16, 2001.

### BACKGROUND OF INVENTION

Night lighting fixtures are used both indoors and outdoors to light walkways, stairs, bathrooms, bedrooms and other places where a low level of illumination is desired for purposes of safety and convenience.

In general, outdoor fixtures are recessed within the wall structure and are connected to the normal electrical wiring system contained in homes, apartments and other buildings. These fixtures usually have an exposed face or plate provided with louvers or other similar openings through which the light passes to provide illumination. The balance of the fixture is recessed and concealed within the wall structure. The light is usually turned on and off manually or by a pre-set timer. Where photocells have been used, the photocell has been separate from the recessed fixture.

In the case of a manually operated fixture, conservation of light and electrical energy is dependent upon timely human intervention. A pre-set timer maintains the period pre-set for illumination and is not responsive to actual external ambient lighting conditions. Consequently, it is possible that the electrical light is turned on when illumination is not needed, and turned off when darkness prevails creating a hazard and risk to security.

Indoor night lights are generally not recessed and project outwardly from the wall, presenting a hazard to children and inconvenience. Outdoor light fixtures are sealed against the elements in many cases. Indoor lights are not sealed and are unsuited for outdoor use.

### SUMMARY OF INVENTION

A night lighting fixture comprising a junction box including at least one front plate, within said junction box an electrical light source and light reflector, said fixture including a visible light detecting photocell, a first opening in said front plate for allowing external ambient light to reach said photocell, said photocell and light source being in electrical communication whereby said photocell is adapted to turn said light source off when the photocell detects ambient light and on when the photocell does not detect ambient light and another opening in said front plate to allow for the passage of light from said electrical light source to provide illumination in the external space.

A structural wall having a night lighting fixture comprising a junction box recessed within said wall, at least one front plate which is exposed on the surface of said wall, within said junction box an electrical light source and light reflector, said fixture including a visible light detecting photocell, a first opening in a front plate for allowing external ambient light to reach said photocell, said photocell and light source being in electrical communication whereby said photocell is adapted to turn said light source off when the photocell detects ambient light and on when the photocell does not detect ambient light and another opening in a said front plate to allow for the passage of light from said electrical light source to provide automatically illumination as required in the external space in response to ambient lighting conditions.

### DESCRIPTION OF PREFERRED EMBODIMENTS

The preferred embodiments of the invention are illustrated by the drawings.

The night lighting fixture of this invention has several important features:

Firstly, the fixture operates automatically to provide night lighting which represents a major security advantage in that night lighting no longer depends on human intervention. Further, no timers are involved so that illumination occurs only actually needed, that is, when darkness or near darkness has arrived.

Secondly, the fixture is recessed within a wall and has nothing which projects outwardly from the wall surface to consume space, interfere with cleaning, or to attract children and thereby expose them to the risk of touching a live electrical contact. The fixture has a flush mounted front plate which conceals the recess.

Thirdly, in one embodiment, the light bulb, preferably the light source is a halogen bulb, the light reflector, photocell and all of the connecting wiring are recessed within the junction box of the fixture. The fixture is essentially self-contained.

Fourthly, the fixture is provided with a recessed photocell which is in light communication with the outside front surface of fixture and is adapted to automatically turn the light “on” in response to darkness and turn the light “off” in response to ambient light. The fixture may also be provided with a flush mounted, front plate which can have a manually operated on-and-off switch to override the photocell operation.

Fifthly, the fixture can be sealed against water and the other elements to make it suitable for installation in outside walls as well as in interior walls.

Sixthly, the fixture is preferably provided with louvers in the front plate through which the illumination from the light source passes. The louvers are configured to cause the illumination to be downwardly directed toward the floor which reduces glare, waste of light, and avoids excessive illumination which can interfere with comfortable sleep.

### THE DRAWINGS

FIG. 1 is a perspective view showing an indoor version of the light fixture of this invention.

FIG. 2 is a perspective view showing an outdoor version of the light fixture of this invention.

FIG. 3 is an exploded view of the embodiment of FIG. 1.

FIG. 4 is an exploded view of the embodiment of FIG. 2.

Turning to the drawings in detail, the lighting fixture, generally 10, includes junction box 12 and front plate or closure 14.

The junction box 12 has an opening or pass—through 16 for the required electrical wiring which leads to and is connected into the normal electrical circuitry found in a home, apartment or other structure.

Within the junction box 12 is light reflector 18 which also has an opening or pass through 20 for the accessing of electrical wiring for the electric bulb 22, preferably a halogen light. The electric bulb 22 is plugged into lampholder 24. The lampholder 24 is connected to the lampholder bracket 26 by screws 28.

A photocell holder 30 acts as a retainer for photocell 32 which is in electrically operative connection to said electrical bulb 22.

The photocell 32 is in proximity at its outer extremity to access opening 34 which enables the photocell 32 to detect the presence or absence of ambient light in the external space beyond plate 14. The photocell may be within the junction box 12 or attached to the outside of the junction box or to the front plate 14 or to the wall structure behind the front plate.

A glass plate 36 may be provided between the inside of front plate 14 and light reflector 18.

The front plate 14 is provided with light louvers 38 which allows light from electrical bulb 22 to pass through the glass plate 36 and front plate 14 when the electrical bulb is turned on to provide night illumination in the space beyond the front plate. The louvers are preferably disposed to direct the illumination onto the floor or walkway to thereby make efficient use of the illumination and to avoid glare.

A manual off and on switch 40 may be provided to override the operation of the photocell 32.

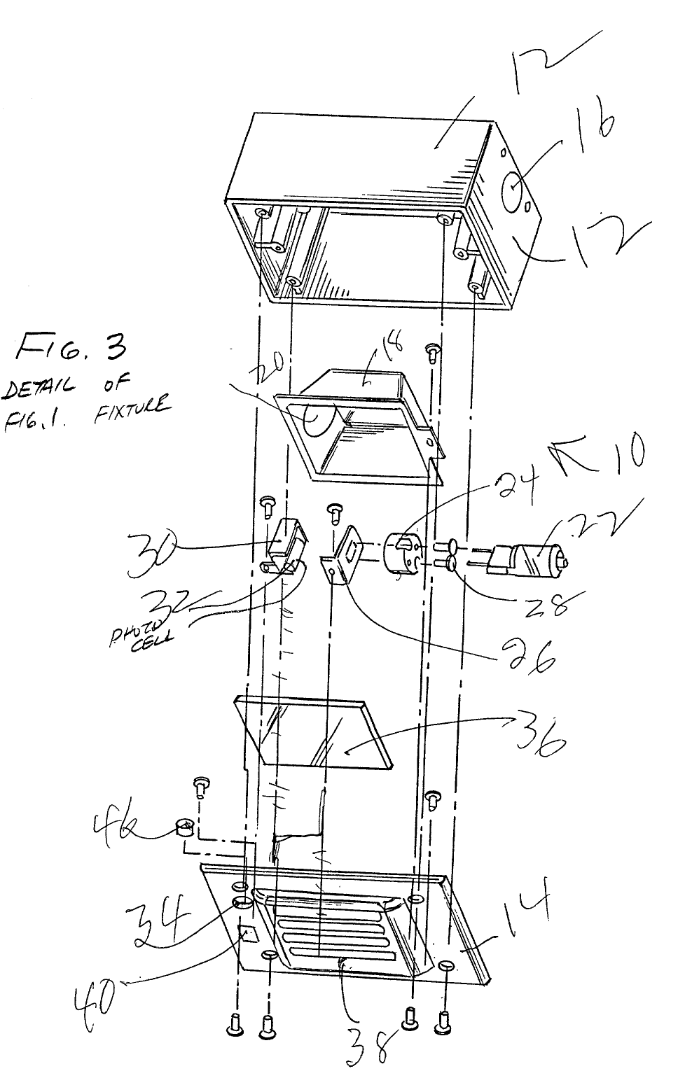

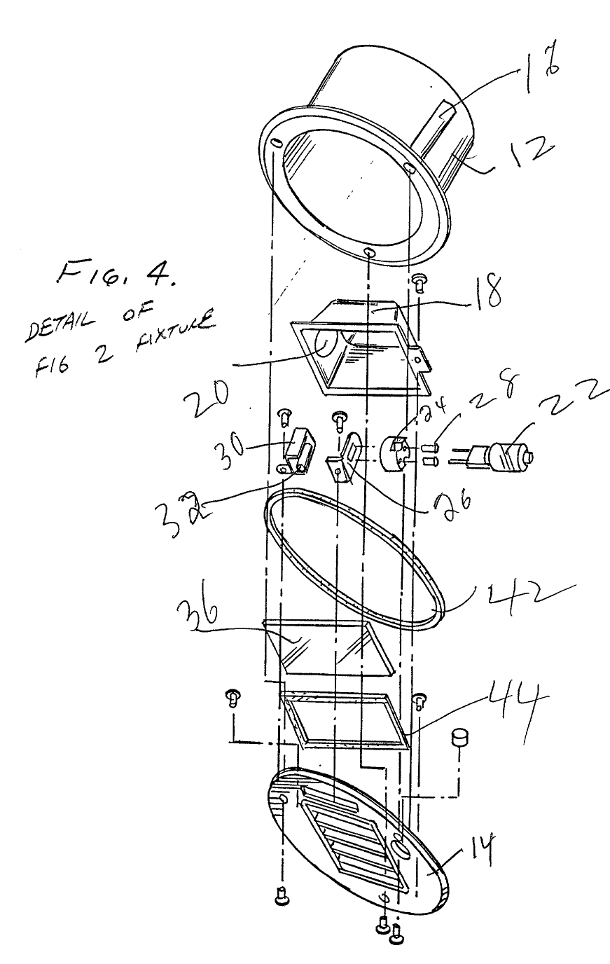

In the embodiment especially of FIGS. 2 and 4, designed for outside use, watertight sealing gaskets 42 and 44 may be provided to make the junction box waterproof and moisture proof. Preferably, the junction box is sealed, making it of universal application, both indoor and outdoor. The junction box containing the light source, light reflector and photocell is self-contained and portable in that it can be easily installed, removed and re-installed.

The opening 34 may be capped by cover 46 if reliance on the photocell is not desired.

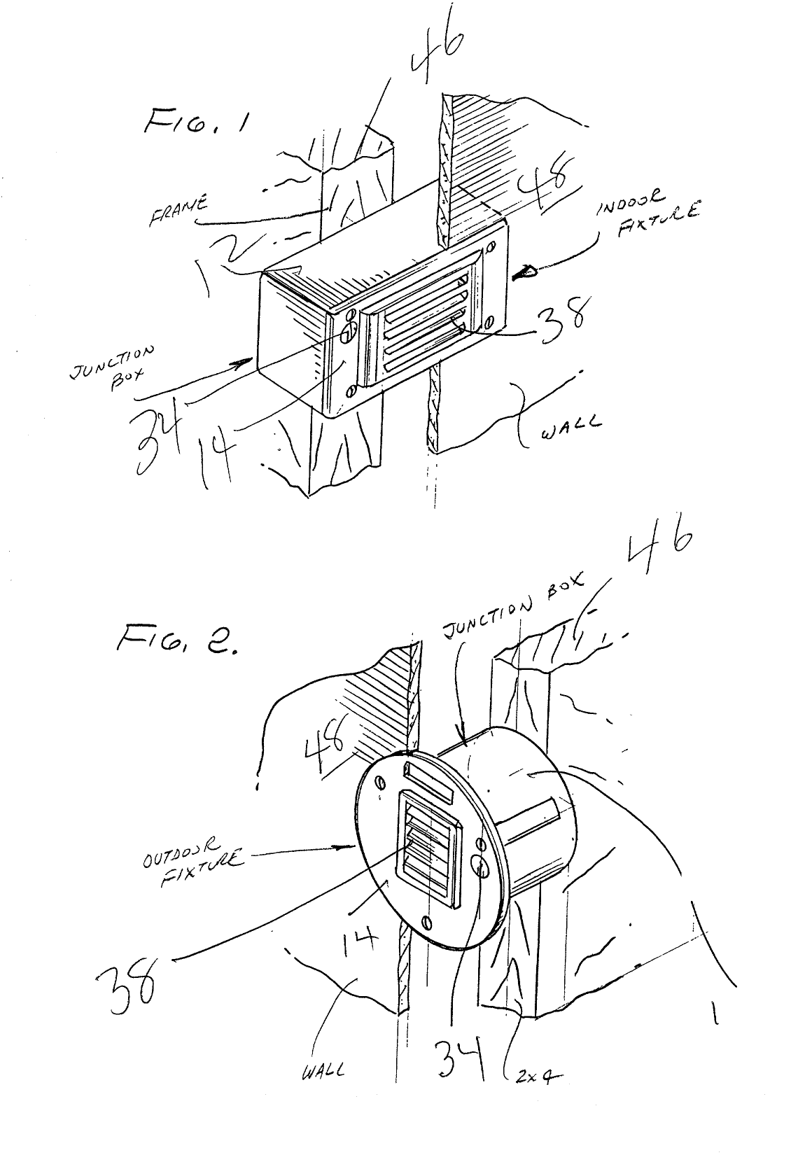

As shown in FIGS. 1 and 2, the night lighting fixture may be attached by screws, for example, to studs 46 forming part of the structural framing. The night lighting fixture may be recessed so that the plate 14 is generally flush with the wall surface 48. The fixture does not intrude into the internal room space and is not subject to accidental damage. The fixture is free of exposed electrical outlets and does not present an attractive nuisance to small children.

The device functions automatically in response to changes in ambient lighting without need for manual manipulation or human tending. The light is turned off and on whether or not someone is at home or on the premises. Thus, this invention provides significant security advantages.

The following are the claims.

1. A night lighting fixture comprising a junction box including at least one front plate, within said junction box an electrical light source and light reflector, said fixture including a visible light detecting photocell, an opening in a front plate for allowing external ambient light to reach said photocell, said photocell and light source being in electrical communication whereby said photocell is adapted to turn said light source off when the photocell detects ambient light and on when the photocell does not detect ambient light and another opening in a front plate to allow for the passage of light from said electrical light source to provide illumination in the external space.

2. The night lighting fixture of claim 1 wherein the electrical light source, light reflector and visible light detecting photocell are contained within said junction box.

3. The night lighting fixture of claim 2 wherein the junction box is sealed to render the interior thereof waterproof and moisture proof.

4. The night lighting fixture of claim 1 wherein an externally accessible on and off switch is electronically connected to said electrical light source to override said light detecting photocell.

5. A structural wall having a night lighting fixture comprising a junction box recessed within said wall, at least one front plate which is exposed on the surface of said wall, within said junction box an electrical light source and light reflector, said fixture including a visible light detecting photocell, an opening in a front plate for allowing external ambient light to reach said photocell, said photocell and light source being in electrical communication whereby said photocell is adapted to turn said light source off when the photocell detects ambient light and on when the photocell does not detect ambient light and another opening in a front plate to allow for the passage of light from said electrical light source to provide automatically illumination as required in the external space in response to ambient lighting conditions.

6. The structural wall of claim 6 wherein there is one front plate which is flush mounted and conceals said junction box.
